(19) United States
(12) Patent Application Publication
(10) Pub. No.: US 2007/0163427 A1
(43) Pub. Date: Jul. 19, 2007

(54) Systems and methods for generating video game content

(76) Inventors: Alex Rigopulos, Cambridge, MA (US); Eran Egozy, Cambridge, MA (US)

Correspondence Address: CHOATE, HALL & STEWART LLP, TWO INTERNATIONAL PLACE, BOSTON, MA, 02110, US

(21) Appl. No.: 11/311,707

(22) Filed: Dec. 19, 2005

(51) Int. Cl. G10H 7/00; A63H 5/00; G04B 13/00

(52) U.S. Cl. 84/609

(57) ABSTRACT

Systems and methods for a creating a music-based video game are described as is a portable music and video device housing a memory for storing executable instructions and a processor for executing the instructions. Creating video game content using musical content supplied from a source other than the game includes analyzing musical content to identify at least one musical event extant in the musical event; determining a salient musical property associated with the at least one identified event; and creating a video game event synchronized to the at least one identified musical event and reflective of the determined salient musical property associated with the at least one identified event.

### FIELD OF THE INVENTION

The present invention relates generally to video games. More specifically, the present invention relates to automatically generating video game content based on data provided by a source external to the game.

### BACKGROUND OF THE INVENTION

Music-based video games are video games that rely on music for a dominant gameplay characteristic. These games have, in many cases, received a high degree of critical acclaim. However, even highly acclaimed music-based video games have not, to date, been as commercially successful as video games from other genres, nor have they been as commercially successful as recorded music products, such as compact discs and albums issued by popular musical artists.

At least one barrier to wider consumption of music-based video games has been the way in which those products are created, marketed, and distributed. Music-based video games are unusual in that, due to the strong emphasis on music in the game, a player's enjoyment of a music-based video game is directly related to the player's enjoyment of the specific music on which the video game is based. Consumer tastes in music vary widely, so a song or artist that is enjoyed by one consumer might be unappealing to a majority of other consumers. Consequently, music-based video games are subject to consumers' highly fragmented taste in music.

Historically, music-based video games generally have not been created based upon the music of a specific popular recording artist or the music under the control of the player of the video game, but rather on a collection of music licensed from a variety of artists or custom-produced for a “general audience” of video game consumers. This approach attempts to provide “something for everyone”, but in practice, the lack of focus fails to provide a critical mass of musical content that will be strongly appealing to any one individual's taste. To truly provide something for everyone, the content of the game should be dynamically configurable and based on the musical content selected by the player of the game.

### SUMMARY OF THE INVENTION

The present invention provides systems and methods for creating video game content from music content, whether provided via an article of manufacture such as a compact disc (CD), digital versatile disc (DVD) or memory device such as a hard drive, read-only memory (ROM) or random access memory (RAM) or provided via wireless or wired network connections. The game code may be distributed with a device specific for playing music e.g., an mp3 player.

In summary, the invention is a music based video game that creates itself from the game player's own favorite music. The inventive video game uses technology that automatically analyzes any song file selected by the player of the game and extracts the rhythm and structural data necessary to create a game level based on the selected song. This turns the game player's personal music collection into an interactive gaming experience. The gaming environment and challenges are created in response to the analyzed song content. In one embodiment, to correctly hear the song, proper gameplay is required.

In one aspect, the invention relates to a method for dynamically creating video game content using musical content supplied from a source other than the game. Musical content is analyzed to identify at least one musical event. A salient musical property associated with the identified event is determined. A video game event synchronized to the identified musical event and reflective of the determined salient musical property associated with the identified event is created. In some embodiments, the determined salient musical property is timbre, pitch range, or loudness. In other embodiments, the musical event is output to the player when the player successfully executes the created game event. In other embodiments, the musical event is modified before it is output to the player based on the player's performance. In still other embodiments, the visual content of video games can be altered responsive to the determined salient musical property of musical events. In these embodiments, the video game can be any genre of game.

In another aspect, the present invention relates to a method for dynamically creating video game content using musical content from a source other than the game. Musical content is analyzed to identify at least one musical event. A video game event is synchronized to the identified musical event is created. The at least one musical event is modified responsive to player input. The modified musical event is output.

In a further aspect, the present invention relates to a portable music and video device housing a memory for storing executable instructions and a processor for executing the instructions, the memory comprising instructions that cause the processor to execute a video game stored in the memory and having a game event that is synchronized to a musical event of musical content supplied from a source other than the video game and to display the video game on a display of the portable music device. In some embodiments, the device is an iPod. In other embodiments, the device is a PSP.

In still further aspects, the present invention relates to a method for altering at least one visual property of a video game responsive to musical content from a source other than the video game. A salient musical property associated with a musical event is determined and a visual property of the game is altered responsive to the determined property.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a diagrammatic view of one embodiment of a rhythm-action video game.

FIG. 2 is a diagrammatic view of another embodiment of a rhythm-action video game.

FIG. 3 is a diagrammatic view of an embodiment of a singing video game.

FIG. 4 is a diagrammatic view of an embodiment of a dancing video game.

FIG. 5 is a diagrammatic view of an embodiment of a music-based third-person character-action game.

FIG. 6 is depicts one embodiment of the steps take to create a video game based on analyzed musical content.

### DETAILED DESCRIPTION

As used herein, creating a video game refers to creating a game level, a portion of a game level, an entire game that includes several game levels, the contents of the environment displayed to user, the game elements used to generate the score of a game player or any combination of those elements. As used in this specification, the term “music-based video game” refers to a game in which one or more of the dominant gameplay mechanics of the game are based on player interaction with musical content. One example of a music-based video game is Karaoke Revolution, sold by Konami Digital Entertainment; in which one of the dominant gameplay mechanics is reproducing, by a player's voice, the pitch and timing of notes from popular songs. Another example of a music-based video game is BeatMania, also sold by Konami; in which game players attempt to strike controller buttons in time to a musical composition. These and other examples are discussed below. In contrast, certain video games have historically utilized the likenesses of popular recording artists and/or music from popular recording artists for the games' soundtracks, but the gameplay itself was not based on player interaction with the soundtrack. One example of such a game is Def Jam Vendetta, sold by Electronic Arts. This is a wrestling game featuring popular hip-hop artists as wrestlers and music from those artists on the soundtrack. The gameplay itself, however, is based simply wrestling and is not, therefore, “music-based” as that term is used in this specification.

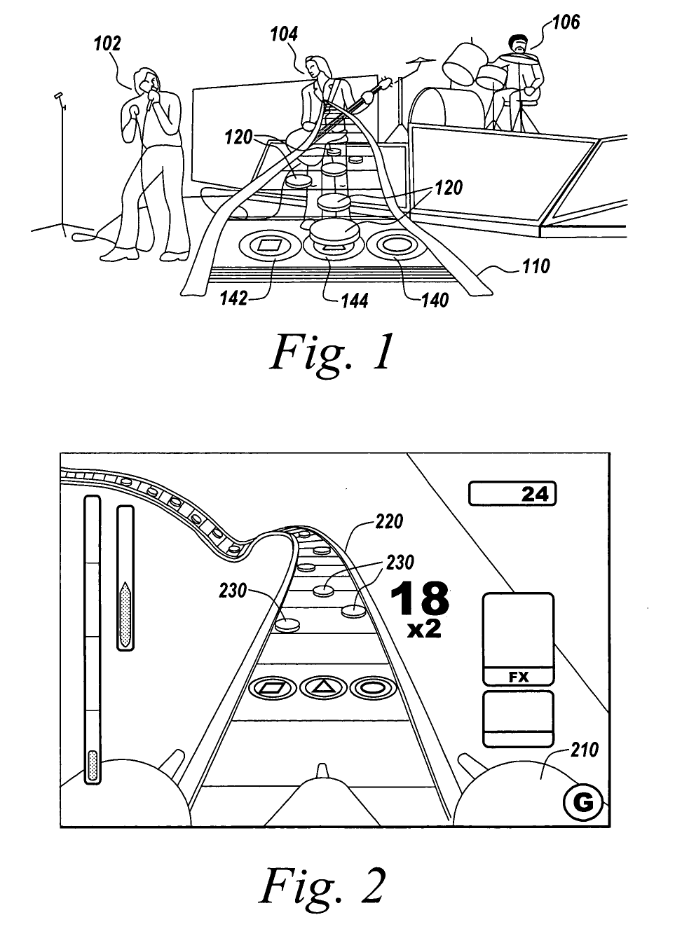

Referring now to FIG. 1, the video game may be based on all, or a portion of, music content created by a popular band enjoyed by specific consumers. FIG. 1 depicts an embodiment of a game in which each of the members 102, 104, 106 of a band has been modeled and animated in the game environment. Various features of the environment (e.g., the lighting and stage props) of the game can be created in accordance with principles of the invention. The game shown in FIG. 1 includes a “lane” 110 that appears to be three-dimensional, that is, it appears to lie in a plane between the player of the game and one of the animated band members. In some embodiments, the lane 10 does not appear to extend to any one particular band member 102, 104, 106, but instead extends to the general area of the “stage” on which the band members 102, 104, 106 reside. In still other embodiments, the player may select a particular band member 102, 104, 106 to which the lane 110 extends using a game controller or other input device. In still further embodiments, the lane may extend to a selected band member based on the musical events for which the musical content is analyzed (e.g., if the musical content is analyzed to determine percussive musical events, the lane 110 may extend to the drummer). The image of the band member may be computer-generated or, alternatively, a digital image, such as a video capture, of the band member may be used.

It is, of course, understood that the display of three-dimensional “virtual” space is an illusion achieved by mathematically “rendering” two-dimensional images from objects in a three-dimensional “virtual space” using a “virtual camera,” just as a physical camera optically renders a two-dimensional view of real three-dimensional objects. Animation may be achieved by displaying a series of two-dimensional views in rapid succession, similar to motion picture films that display multiple still photographs per second.

To generate the three-dimensional space, each object in the three-dimensional space is typically modeled as one or more polygons, each of which has associated visual features such as texture, transparency, lighting, shading, anti-aliasing, z-buffering, and many other graphical attributes. The combination of all the polygons with their associated visual features can be used to model a three-dimensional scene. A virtual camera may be positioned and oriented anywhere within the scene. In many cases, the camera is under the control of the viewer, allowing the viewer to scan objects. Movement of the camera through the three-dimensional space results in the creation of animations that give the appearance of navigation by the user through the three-dimensional environment.

A software graphics engine may be provided which supports three-dimensional scene creation and manipulation. A graphics engine generally includes one or more software modules that perform the mathematical operations necessary to “render” the three-dimensional environment, which means that the graphics engine applies texture, transparency, and other attributes to the polygons that make up a scene. Graphic engines that may be used in connection with the present invention include Realimation, manufactured by Realimation Ltd. of the United Kingdom and the Unreal Engine, manufactured by Epic Games. Although a graphics engine may be executed using solely the elements of a computer system recited above, in many embodiments a graphics hardware accelerator is provided to improve performance. Generally, a graphics accelerator includes video memory that is used to store image and environment data while it is being manipulated by the accelerator.

Graphics accelerators suitable for use in connection with the present invention include: the VOODOO 3 line of graphics boards manufactured by 3dfx Interactive, Inc. of San Jose, Calif.; the RAGE line of graphics boards, manufactured by ATI Technologies, Inc. of Thornhill, Ontario, Canada; the VIPER, STEALTH, and SPEEDSTAR lines of graphics boards manufactured by S3, Inc. of Santa Clara, Calif.; the MILLENIUM line of graphics boards manufactured by Matrox Electronic Systems, Ltd. of Dorval, Quebec, Canada; and the TNT, TNT2, RIVA, VANTA, and GEFORCE256 lines of graphics boards manufactured by NVIDIA Corporation, of Santa Clara, Calif.

The special abilities of the graphics system are made available to programs via an application programming interface (API). DIRECT3D, a standard API manufactured by Microsoft Corporation of Redmond, Wash. may be used and provides some level of hardware independence. The API allows a program to specify the location, arrangement, alignment, and visual features of polygons that make up a three-dimensional scene. The API also allows the parameters associated with a virtual camera to be controlled and changed.

In other embodiments, a three-dimensional engine may not be used. Instead, a two-dimensional interface may be used. In such an embodiment, video footage of a band can be used in the background of the video game. In others of these embodiments, traditional two-dimensional computer-generated representations of a band may be used in the game. In still further embodiments, the background may only slightly related, or unrelated, to the band. For example, the background may be a still photograph or an abstract pattern of colors. In these embodiments, the lane 110 may be represented as a linear element of the display, such as a horizontal, vertical or diagonal element.

FIG. 1 depicts an embodiment of a rhythm-action video game that includes a lane 110 that has one or more game “cues”, “elements” or “gems” 120 corresponding to musical events distributed along the lane 110. The lane 110 is a representation of the musical time axis. As shown in FIG. 1, the lane 110 does not always extend perpendicularly from the image plane of the display. In further embodiments, the lane 110 may be curved or may be some combination of curved portions and straight portions. In still further embodiments, the lane 110 may form a closed loop through which the game elements 120 travel, such as a circular or ellipsoid loop. In some embodiments, the time axis lies in the plane of the display. In still other embodiments, the surface of the lane may be subdivided along the time axis into a plurality of segments. Each segment may correspond to some unit of musical time, such as a beat, a plurality of beats, a measure, or a plurality of measures. The segments may be equally-sized segments, or each segment may have a different length depending on the particular musical data to be displayed. In addition to musical data, each segment may be textured or colored to enhance the interactivity of the display.

The cues appear to flow toward the game player and are distributed on the lane 110 in a manner having some relationship to musical content associated with the game level. For example, the cues may represent note information (gems spaced more closely together for shorter notes and further apart for longer notes, pitch (gems placed on the left side of the lane for notes having lower pitch and the right side of the lane for higher pitch), volume (gems may glow more brightly for louder tones), duration (gems may be “stretched” to represent that a note or tone is sustained), articulation, timbre or any other time-varying aspects of the musical content. The elements 120 result from the analysis of the musical content associated with the game level. As described below, the elements 120 may be dynamically created from musical content provided by the player. Although shown in FIG. 1 as a small orb, or gem, the game elements 120 may be any geometric shape, and may have other visual characteristics, such as transparency, color, or variable brightness.

Player interaction with the game element 120 may be required in a number of different ways. In one embodiment, the player may have to “shoot” the game element 120 by pressing a game controller button in synchronicity with the passage of the game element 120 under a target marker 140, 142, 144, much like the game play mechanics in two rhythm-action games published by Sony Computer Entertainment America for the PlayStation 2 console: FreQuency and Amplitude. In another embodiment, the player operates a “scoop” that slides back and forth along the lane 110 (or other visual display of the musical time axis). The player must keep the scoop aligned with the game elements as they flow toward the player, much like one of the game play mechanics featured in a rhythm-action game published by Koei, Gitaroo-man. The player may interact with the game using a traditional controller, such as a PlayStation 2 Controller. In other embodiments, the player may use a computer keyboard to interact with the game. In still other embodiments, the player may use specialized controllers to interact with the game, such as a Guitar Hero SG Controller, manufactured by RedOctane of Sunnyvale, Calif. or a USB microphone of the sort manufactured by Logitech International of Switzerland.

As the game elements 120 move along the lane 110, the musical data represented by the game elements 120 may be substantially simultaneously played as audible music. In some embodiments, audible music is only played (or only played at full or original fidelity) if the player successfully “performs the musical content” by shooting or scooping the game elements 120. In certain of the embodiments shown in FIG. 1, successfully performing the musical content triggers or controls the animations of the band members 102, 104, 106. In other embodiments, the audible audio is modified, distorted, or otherwise manipulated in response to the player's proficiency in shooting, scooping, or otherwise executing the game elements 120. For example, various digital filters can operate on the audible output prior to being played the game player. Various parameters of the filters can be dynamically and automatically modified in response the player capturing the elements 120, allowing the audio to be degraded if the player performs poorly or enhancing the audio if the player performs well. For example, if a player fails to execute a game event, the audio represented by the failed event may be muted, played at less than full volume, or filtered to alter the its sound. Conversely, if a player executes a game event, the audio may be played normally. In some embodiments, if the player successfully executes several, successive game events, the audio associated with those events may be enhanced by, for example, adding an echo or “reverb” to the audio. It should be understood that the filters can be implemented as analog or digital filters in hardware, software, or any combination thereof. Further, application of the filter to the audible output, which in many embodiments corresponds to musical events represented by the game elements 120, can be done dynamically, that is, during play. Alternatively, the musical content may be processed before game play begins. In these embodiments, one or more files representing modified audible output may be created and musical events to output may be selected from an appropriate file responsive to the player's performance.

In addition to modification of the audio aspects of game events based on the player's performance, the visual appearance of those events may also be modified based on the player's proficiency with the game. For example, failure to execute a game event properly may cause game interface elements to appear more dimly. Alternatively, successfully executing game events may cause game interface elements to glow more brightly. Similarly, for embodiments such as FIG. 1 in which game characters are depicted, the player's failure to execute game events may cause the game characters to appear embarrassed or dejected, while successful performance of game events may cause the characters to appear happy and confident. In this manner, the embodiment of a rhythm-action game depicted in FIG. 1 can be used to create an interactive music video in which the game player “controls” one or more computer-generated or digitized images of musicians using a game controller. In these embodiments, successfully shooting or scooping game elements 120 on a lane 110 extending to the digitized image of the musical artist causes the computer generated musical artist to play an instrument and successfully executing a number of successive game elements 120, or notes, may cause the corresponding animated band member to execute a “flourish,” such as kicking their leg, pumping their fist, performing a guitar “windmill” or throwing drum sticks. In some embodiments, the player is not visually controlling a computer generated on-screen musician at all; the images of the musicians are digitized video captured, and the player's interaction is only with the musical content.

Referring now to FIG. 2, another embodiment of a rhythm-action video game is shown in which a lane 220 that appears to be three-dimensional represents a musical characteristic of musical content. As will be familiar to those having experience with two games sold by Sony Computer Entertainment America, FreQuency and Amplitude, the player controls a “beat blaster” 210 to travel along lanes 220 and shoot, in synchrony with musical content, the music game elements 230 displayed on the lane 220. Successfully shooting game elements 230 causes the music associated with the game element 230 to be played. Except for the absence of the digitized images of band members responding to game activity, gameplay mechanics are the same as those described above in Example 1. Other examples of rhythm-action games include Parappa the Rapper, Beat Planet Music, Stolen Song, and EyeToy: Groove, all of which are sold by Sony Computer Entertainment; BeatMania, DrumMania, KeyboardMania, and Guitar Freaks, all of which are sold by Konami Digital Entertainment; Taiko no Tatsujin, sold by Namco; Donkey Konga, sold by Nintendo; Quest for Fame, sold by International Business Machines; Mad Maestro, sold by Eidos; Space Channel 5, sold by Sega; and Gitaroo-man, sold by Koei.

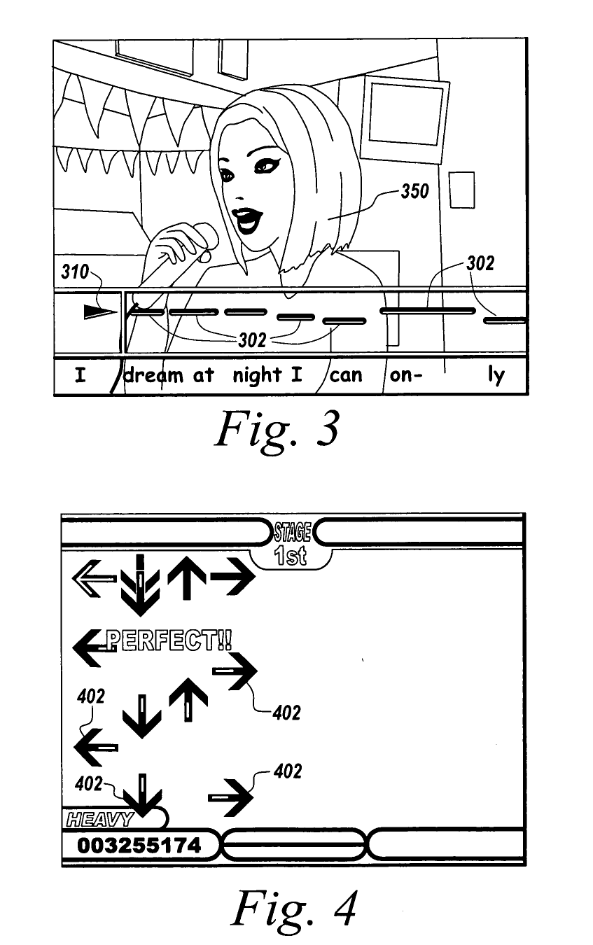

Referring now to FIG. 3, an embodiment of a “sing-along” video game is shown, which requires that a player “sing-along,” i.e., provide vocal input matching the pitch and duration of notes included in musical content associated with the game level. As shown in FIG. 3, the notes of a vocal track are represented by “note tubes” 302 that appear along the bottom of the gameplay screen and flow horizontally as the music plays. The vertical position of the note tube represents the pitch to be sung by the player; the length of the note tube indicates for how long the player must hold that pitch. The triangle 310 provides the player with visual feedback regarding the pitch of the note that is currently being sung.

In other embodiments, the gaming platform may provide additional input devices allowing the player to “karaoke” more than just the vocal track. In embodiments in which the gaming platform is provided with a camera, the camera may be used to capture movements of the player such as the position and movements of the player's hands, allowing the player to attempt to play along with the drum track for a musical composition while singing. In other embodiments, the gaming platform may provide an input device having foot-actuable elements, such as dance pads of the sort manufactured by Red Octane of Sunnyvale, Calif. In these embodiments, the player's performance may be determined based on execution of vocal game events as well as “dance” game events.

Other examples of “sing-along” video games include Karaoke Revolution, sold by Konami Digital Entertainment; SingStar by Sony Computer Entertainment and Get On Da Mic by Eidos.

Referring now to FIG. 4, an embodiment of a “dance-along” video game is shown, in which a player is required to execute specific dance moves in synchrony with music content. “Dance-along” games are a sub-genre of rhythm-action games, described above. As can be seen from FIG. 4, specific dance moves are indicated to the player as directional arrows 402 on the side of the game screen representing various foot positions. This exemplary game allows a player to “dance-along” with the musical content on which the video game is based. In embodiments in which the gaming platform is provided with a camera, the camera may be used to capture movements of the player. In other embodiments, the player's dance moves may be captured by a floor pad that is connected to the gaming platform.

Other examples of “dance along” video games include Dance Dance Revolution, sold by Konami Digital Entertainment; EyeToy:Groove, sold by Sony Computer Entertainment and Bust A Groove, sold by Square Enix. Further examples include, “In the Groove, sold by RedOctane, “Pump It Up” sold by Andamiro, “Dance Factory” sold by Codemasters, and Goo Goo Soundy, sold by Konami.

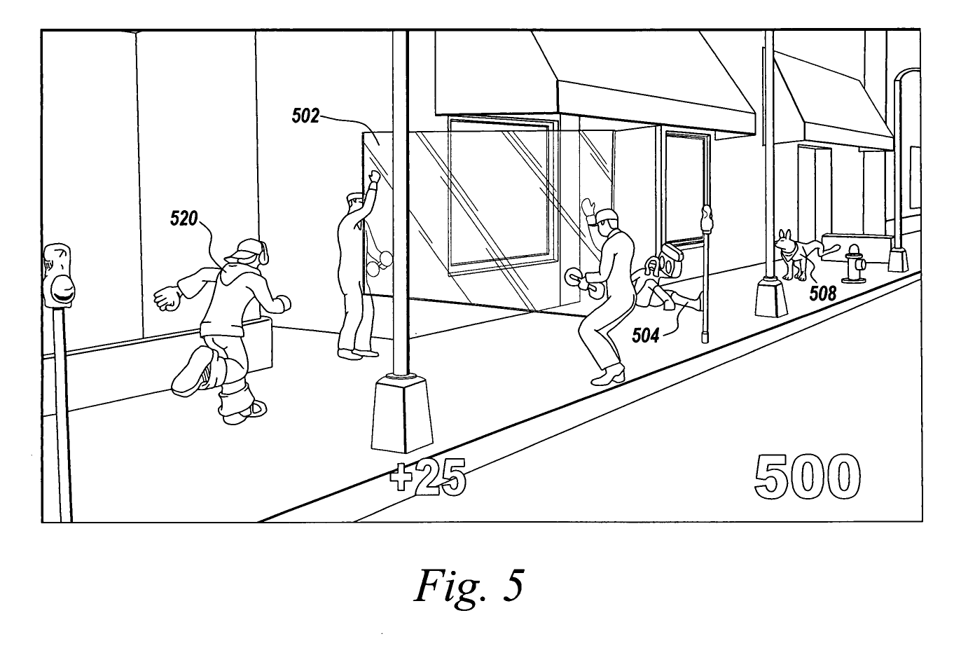

Referring now to FIG. 5, an embodiment of a music-based character-action game is shown in which musical events are represented as specific obstacles 502, 504, 506. The player must control a game character 520 to avoid the obstacles 502, 504, 506, which appear in the game character's path in synchronicity with musical events from the musical content associated with the game level. The player must control the game character 520 to “dodge” the obstacles 502, 504, 506 by, for example, pressing game controller buttons in synchronicity with the musical events. Other examples of music-based third-person character-action games include VibRibbon and MojibRibbon, both by Sony Computer Entertainment.

In another embodiment, the music-based video game features gameplay like that found in Rez, a “musical shooter” sold by Sega. In these games, the player navigates through a game environment. The player controls a targeting device to choose and shoot targets that exist in the game environment. As the player shoots targets, musical events are triggered that contribute to a soundtrack for the game. The gameplay for these types of games is similar to other “shooter” type games, with the exception that shooting targets directly and explicitly contributes to the musical accompaniment provided by the game.

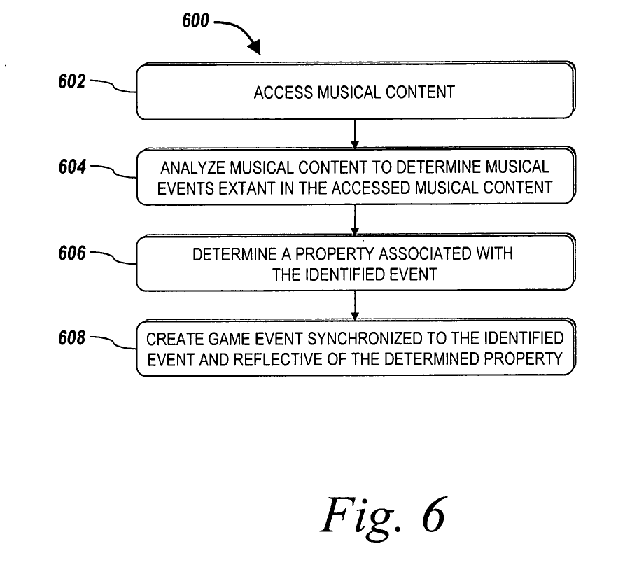

Referring now to FIG. 6, and in brief overview, a method 600 for creating a video game based on provided musical content includes the steps of accessing musical content (step 602), analyzing the accessed musical content to identifying a plurality of musical events extant in the accessed musical content (step 604); determining a property associated with each of the identified events (step 606); and creating a game event synchronized to the identified event and reflective of the determined property (step 608).

Still referring to FIG. 6, and in greater detail, the musical content may be accessed (step 602) in a variety of ways. In one embodiment, the game player provides the desired musical content for creating the game by way of a complete recorded music product on compact disc (CD), mini disc (MD) digital versatile disc (DVD), Universal Media Disc (UMD), or digital audio tape (DAT), such as an entire album, extended play (EP) product or “single.” In other embodiments, the provided music product may be fixed in a removable storage medium such as a flash memory card. The provided music can also be fixed in a storage device such as a hard drive in a portable music/video player, sometimes referred to as an “MP3 player.” In these embodiments, the musical content may be provided in a number of different digital formats such as mp3, aac, aiff, wav, or wmv. In these embodiments, the digital music file may be read and copied into a buffer from which the digital music data may be read. In other embodiments, the musical data can be read directly from a CD, DVD or memory device.

In other embodiments, the musical content may be accessed via a network, such as a personal area network (PAN), local area network (LAN), a metropolitan area network (MAN), or a wide area network (WAN) such as the Internet using a variety of connections including standard telephone lines, LAN or WAN links (e.g., T1, T3, 56 kb, X.25), broadband connections (ISDN, Frame Relay, ATM), and wireless connections (Bluetooth, GSM, CDMA, W-CDMA). A variety of data-link layer communication protocols may be employed (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g and direct asynchronous connections). Further, in these embodiments the received musical content may be encrypted using any one of a number of well-known encryption protocols, e.g., DES, triple DES, AES, RC4 or RC5. In these embodiments, the musical content may be downloaded to the portable music device as needed.

Still referring to FIG. 6, the accessed musical content is analyzed to determine a plurality of musical events extant in the accessed musical content (step 604). Identified musical events can include beats, percussive events (such as snare drum, tom-tom, or bass drum “hits”), notes, transition in musical structure (such as the transition from chorus to verse), and recurrence of a musical patterns. Musical properties of the identified musical events may also be determined. Musical properties may include, but are not limited to, the pitch, timbre, loudness, tone color and spectral distribution of an event. For example, a note or closely-grouped series of notes is a musical event. The pitch of the note is a property of that note event. The property may be used to infer information about a particular event. For example, if it is determined that a percussive event has occurred and the event has a “high” pitch and “bright” timbre, it can be inferred that the identified event is a snare drum “hit.”

In one particular embodiment, identifying the musical events (step 604) and determining the musical properties associated with the events is performed by preprocessing the musical content to emphasize the attacks in the music (audio sound). The emphasized audio signal can be expressed by the ratio (Ps/PI) of a short term power Ps to a long term power Pl in the audio signal. After thresholding, the peak emphasized signal (short term power Ps/long term power Pl) during each select period is chosen as a potential musical event. This technique is described in greater detail in U.S. Pat. No. 6,699,123 B2.

In other embodiments, known techniques for extracting audio events or transients from an audio signal containing music may be used to identify musical events and determine properties associated with those events. Some of these approaches decompose the audio signal into frequency sub-bands by either using the Short-Time-Fourier Transform (STFT) or by using a bank of bandpass filters and finding the envelopes of the resultant signals. Thereafter, a derivative and half-wave rectifier provides a signal that can be compared to a threshold to find locations of audio events or transients. Further details of these techniques are described in: Klapuri, Anssi. “Musical meter estimation and music transcription.” Paper presented at the Cambridge Music Processing Colloquium, Cambridge University, UK, 2003; Paulus, Jouni and Anssi Klapuri. “Measuring the similarity of rhythmic patterns.” Third International Conference on Music Information Retrieval (ISMIR 2002) Paris, France, Oct. 13-17, 2002; and Scheirer, Eric. “Tempo and beat analysis of acoustic musical signals.” Acoustic Society of America, 103, no. 1 (1998): 588-601.

Other known techniques for extracting audio events or transients from an audio signal containing music focus on finding transients of a particular type such as percussive sounds. For examples of these techniques, see Zils, Aymeric, François Pachet, Olivier Delerue and Fabien Gouyon. “Automatic Extraction of Drum Tracks from Polyphonic Music Signals” Proceedings of International Conference on Web Delivering of Music, Darmstadt, Germany, 2002.

In still other embodiments, the tempo and beats of an audio musical signal may be determined by using a large set of resonant comb-filters that are applied to the audio sub-band as described above. Some of these techniques, which may be used to identify musical events and determine properties associated with those events, are described in the following: Klapuri, Anssi. “Musical meter estimation and music transcription.” Paper presented at the Cambridge Music Processing Colloquium, Cambridge University, UK, 2003; Paulus, Jouni and Anssi Klapuri. “Measuring the similarity of rhythmic patterns.” Third International Conference on Music Information Retrieval (ISMIR 2002) Paris, France, Oct. 13-17, 2002; and Scheirer, Eric. “Tempo and beat analysis of acoustic musical signals.” Acoustic Society of America, 103, no. 1 (1998): 588-601.

In further embodiments, musical events are determined and properties of those events identified using a multi-agent system based on detected transients. Details of these techniques can be found in: Dixon, Simon. “Automatic Extraction of Tempo and Beat from Expressive Performances.” Journal of New Music Research 30, no. 1, (2001): 39-58 and Dixon, Simon. “A Lightweight Multi-Agent Musical Beat Tracking System.” Proceedings of the Pacific Rim International Conference on Artificial Intelligence, PRICAI 2000, Melbourne, Australia, 2000. In certain of these embodiments, autocorrelation of low-level features (i.e., transients) is used to create a pool of weighted candidates for tempo and phase. For example, see Gouyon, Fabien and P. Herrera. “A beat induction method for musical audio signals” Proceedings of 4th WIAMIS-Special session on Audio Segmentation and Digital Music; London, UK, 2003. In still further of these embodiments a more complex probabilistic modeling system known as particle filtering is used to identify musical events and determine properties associated with those events. Details of these techniques can be found in Hainsworth, Stephen and Malcolm D. Macleod. “Beat Tracking with Particle Filtering Algorithms” In Proceedings of the IEEE Workshop on Applications of Signal Processing to Audio and Acoustics, Mohonk, N.J., Oct. 19-22, 2003 and Hainsworth, Stephen W., and Malcolm D. Macleod. “Particle Filtering Applied to Musical Tempo Tracking.” EURASIP Journal on Applied Signal Processing 2004, no. 15 (2004): 2385-2395.

Additionally, techniques may be used that infer larger time-scale information from a musical audio signal. These techniques are useful for identifying unique or repetitive song sections. For example, in popular music, some of these song sections are the introduction, verse, chorus, and bridge sections. In certain techniques, a pitch counter is extracted, a similarity matrix is computed, and a clustering algorithm finds similar sequences. Details of these techniques are found in: Dannenberg, Roger B. and Ning Hu. “Discovering Musical Structure in Audio Recordings.” 2nd International Conference on Music and Artificial Intelligence, (ICMAI 2002), Edinburgh, Scotland, Sep. 12-14, 2002; Dannenberg, Roger B. “Listening to ‘Naima’: An Automated Structural Analysis of Music from Recorded Audio.” Proceedings of the International Computer Music Conference, International Computer Music Association, San Francisco, 2002; and Dannenberg, Roger B. and Ning Hu. “Pattern Discovery Techniques for Music Audio.” Third International Conference on Music Information Retrieval, (IRCAM), Paris, France, 2002.

More general approaches do not depend on pitch counters and instead work on a summarized spectral analysis of the audio stream and a more sophisticated probabilistic clustering algorithm. Details of these approaches are described in: Foote, Jonathan. “Automatic Audio Segmentation using a Measure of Audio Novelty.” Proceedings of IEEE International Conference on Multimedia and Expo, vol. 1, 2000; Foote, Jonathan and Shingo Uchihashi, “The Beat Spectrum: A New Approach to Rhythm Analysis,” Proceedings International Conference on Multimedia and Expo (ICME), 2001; Foote, Jonathan and Matt Cooper, “Media Segmentation using Self-Similarity Decomposition.” Proceedings SPIE Storage and Retrieval for Multimedia Databases, vol. 5021, San Jose, Calif., January 2003; and Jehan, Tristan. “Perceptual Segment Clustering For Music Description and Time-Axis Redundancy Cancellation” Proceedings of the International Symposium on Music Information Retrieval (ISMIR). Barcelona, Spain, October 2004.

Still referring FIG. 6, a game event is created synchronized to the identified events and reflective of the determined musical property (step 608). Game events may differ based on the type of video game that is created. For example, referring back to FIG. 1, game events can include the intersection of the gems with the target markers, indicating that input is required from the user. The game event, i.e., the input required of the user, such as which button to press, can be reflective of the salient musical property of the musical event. Game events may be created during active gameplay by the player. Alternatively, musical content may be processed to create game events prior to gameplay. In these embodiments, the game events may be saved as a file accessible by the video game during execution.

Referring back to FIG. 3, musical events (notes to be sung) may be represented by the appearance of a note tube 302 instructing the player to sing. The pitch of the note to be sung is the determined musical property of the event, and the vertical location of the note tube changes to reflect the pitch of the note. As shown in FIG. 4, a musical event may be used to create a directional arrow 402 at a specific point in time, which instructs the player to dance in the manner instructed by the arrow 402. The direction may be chosen reflective of a property of the identified musical event, such as the pitch, loudness, or tone color of the musical content at the time the beat is identified. For example, supplied musical content may be analyzed for percussive events and a series of percussive events may be identified having properties that indicate a pattern of snare drum and bass drum hits such as snare-bass-snare-snare-bass. In this example, the directional arrows may reflect the snare drum-bass drum pattern by instructing the player to step left-right-left-left-right in time with the drum pattern.

Further, aspects of the game may be altered to reflect musical events and their properties. For example, referring back to FIG. 1, the appearance of the band members 102, 104, 106 (e.g., their clothing, hairstyles, instruments, and skin tone) may be altered to reflect the “tone” of the music, as identified by the determined musical events and their associated properties. In still other embodiments, the background for the game, i.e., the stage in FIG. 1, may be altered to reflect the determined events and associated musical properties. In other embodiments, the brightness of the background may be altered to reflect the determined events. For example, a brighter background may be provided for louder musical content. In some embodiments, the background may be caused to flash in synchronicity with a determined percussive event. Similarly, the shape, size, coloring, and other similar features of game elements 120, 230, 302, 402 can be varied based on the analysis of the musical content. In still further embodiments, the shape of the lane 110, 220 and the shape of the music blaster 210 may be altered. In short, any element of the visual display may be altered to reflect the determined properties of the identified musical events.

In some embodiments, the described technique of altering background game content responsive to musical properties of identified game events may by applied to game types other than rhythm-action games, such as first person shooters, adventure games, real-time strategy games, role-playing games, turn-based strategy games, platformers, racing simulation games, sports simulation games, survival-horror games, stealth-action games, and puzzle games. For example, a player of a first-person shooter game may provide musical content in which the musical events are determined to have slow, dark properties. In response, the lighting in the first-person shooter may reflect those musical properties, by dimming light sources in the game or selecting a more muted palette of colors to use on objects in the game.

In some embodiments, only a single game event may occur at one time. In these embodiments, overlapping musical events are resolved so that only a single game element is displayed on the screen for any particular time. An event's time extent is its “game event period”. The minimum time between two events is determined. For example, in one embodiment, the minimum time between two events is a duration equaling 100 milliseconds—this is called the event's “shadow period”. No event may occur in another event's shadow period. In this manner, final event signals (final event array) having a series of final events is generated. When each of the final events is reproduced, one video game object is displayed. In another embodiment, more than one video game object can be displayed. For example, a change in lighting and a gem can be created using the same subset of events from the final events.

Each final event may be mapped to a specific type of game element. For example, a subset of contiguous final events can be mapped to require a specific sequence of buttons to be pressed by the player in a specific rhythm to successfully execute one or more musical events. In one embodiment, the shape of each gem displayed in each of the final events is determined based a predetermined sequence distribution or weight random distribution.

In one embodiment, salient features to the user (e.g., pitch, timbre, and loudness) are used to determine the proper button assignment for the gem. A user interface can be provided to the game player prior to analyzing the musical content to allow the game player define which features of the musical content are of most interest to the game player. In other embodiments, the mapping between musical properties and game input is predetermined.

As an example, assume a music game created by the invention involves three buttons that the game player must press in synchrony with musical events, and some salient property of each musical event determines which button the player must press for that event. In the case where that musical property is pitch, then musical events of “generally low pitch” may be assigned to a first button, those of “generally high pitch” may be assigned to the third button, and those of moderate pitch may assigned to the second button, which is between the first button and the second button. This configuration can be also be mapped to the iPod clickwheel. The clickwheel can be thought of as a clock face. The first button can be nine o'clock, the second button can be twelve o'clock, and third button can be three o'clock.

Similarly, if loudness/volume is selected as a salient musical property, then musical events of “generally low volume” may be assigned to the first button, those of “generally high volume” may be assigned to the third button, and those of moderate volume may be assigned to the second button.

Finally, in the case where the salient musical property is timbre, then musical events of one type, e.g. “noisy” (like a snare drum, for example) are assigned to one button, musical events of another type, e.g. “boomy” (like a kick drum) are assigned to another button.

It should be understood that these button mappings can apply to a traditional Playstation, Playstation 2, X-box, X-box 360, or Nintendo game cube controller. Only a Playstation 2 example will be provided for simplicity. Assuming three buttons are used, a first game event is mapped to the LI button, a second game event is mapped to the R1 button, and a third game event is mapped to the R2 button. In another embodiment, the first game event is mapped to the “square” button, the second game event is mapped to the “triangle” button, and the third game event is mapped to the “circle” button.

In addition to mapping musical events to single game objects with characteristics reflective of musical properties of the associated musical events, musical events can be mapped to a group of game objects. For example, and referring again to the game Amplitude sold by Sony Computer Entertainment America, game play rewards are based upon the game player's successful execution of a group (also referred to as phrase) of notes. The analysis of the musical content can reveal phrases or groups of notes of interest, such as a riff that is repeated or a series of notes that recur. Alternatively, the groupings can be assigned post analysis by the software of the invention. Said another way, “phrases” can either be a function of the musical analysis (e.g., the music analysis engine successfully identifying phrases. by identifying repeating patterns in the audio), or the gameplay phrases could have nothing to do with identified sequences of musical events in the musical content. For example, an arbitrary number of musical events in sequence could be identified as a phrase.

Other musical events that can be mapped to game events can include section changes (e.g., from verse to chorus). In one embodiment, these changes translate into visual changes in the background environment (e.g., the three dimensional space surrounding the characters) of the video game. These changes can include lighting, coloring, texturing, and other visual effects, stage appearance, character appearance, character animation, particle system parameters, and the like.

Said another way, the process of generating the video game environment is a dynamic process whereby properties of the supplied musical content are directly connected to graphical properties of the game environment. The properties of the video game environment are not necessarily governed by gameplay. One example includes having the loudness of the supplied musical content cause the video game environment lighting to increase or decrease in brightness. In another example, the frequency distribution of the music changes the color of the lighting being applied to the environment. In another example, the loudness of the supplied musical content affects some property of the animation of objects in the environment (e.g. animated performing musicians start “rocking out harder” when the music is louder) or deformed surfaces.

The described systems and methods may execute on a wide variety of gaming platforms or devices. The gaming platform may be a personal computer, such as any one of a number of machines manufactured by Dell Corporation of Round Rock, Tex., the Hewlett-Packard Corporation of Palo Alto, Calif., or Apple Computer of Cupertino, Calif. Although games manufactured to be played on personal computers are often referred to as “computer games” or “PC games,” the term “video game” is used throughout this description to refer to games manufactured to be played on any platform or gaming device, including personal computers.

In other embodiments the game platform is a console gaming platform, such as GameCube, manufactured by Nintendo Corp. of Japan, PlayStation 2, manufactured by Sony Corporation of Japan, or Xbox 360, manufactured by Microsoft Corporation of Redmond, Wash. In still other embodiments, the game platform is a portable device, such as GameBoy Advance, manufactured by Nintendo, the PSP, manufactured by Sony or the N-Gage, manufactured by Nokia Corporation of Finland.

In other embodiments, the described systems and methods may execute on an electronic device such as a portable music/video player. Examples of such players include the iPod series of players, manufactured by Apple Computer or the line of MP3 players manufactured by Creative Labs. In still further embodiments, the described methods may operate on a cellular telephone.

The software can be provided to the gaming device in many ways. For example, the software can be embedded in the memory of the gaming device and provided with the purchase of the gaming device. Alternatively, the software can be purchased and downloaded to the gaming device, either via a wireless network or a wired network. Additionally, the software can be provided on a tangible medium that is read by the gaming device. In one embodiment, the video game generation software can be preprogrammed into a portable music/video device such as an iPod, PSP, or another portable music/video device.

In still other embodiments, the software is offered for download. In some specific embodiments, the software may be offered for download from a source traditionally associated with the download of music products, such as the iTunes Store, operated by Apple Computer of Cupertino, Calif. In such an embodiment, the software may be stored on a general purpose computer as part of the iTunes application. The iTunes application and downloaded software can generate the video game and transfer the game to an ipod during a synchronization process. In another embodiment, the iPod itself can receive the downloaded software and generate the video game itself.

### EXAMPLES

The following examples illustrate various game play scenarios on a variety of portable music devices. The examples are not exhaustive of all possibly combinations and configurations of game play within the spirit and scope of the invention.

### Example 1

With reference back to FIG. 1, an example of generating a video game and corresponding game play is described below. As shown, the band consists of three members a vocalist 102, a guitarist 104, and a drummer 106. In one embodiment, the number of band members corresponds to the number of actual band members of the selected musical content. For example, if the game player provides a compact disc containing music performed by the popular rock group Rush, the invention performs a CDDB query to determine information about the CD. In response, the CDDB database informs the software that the music is performed by Rush. The system for generating the video game then performs a local database lookup to determine if it has information regarding the band Rush. The database may store images to use in generating the game. The database may also store data that acts as “hints” to the analysis engine to help the system create the video game level. The invention can access a plurality of stored “avatars” stored in the database that correspond to the band members of the selected musical content. For example, if the user provides a Rush compact disc, the vocalist 102, guitarist 104, and drummer 104 used in the video game may be images of the band members, Geddy Lee, Alex Lifeson, and Neil Peart. In the event that the local database does not store information about the band, the system may access a database via a network to determine such information. In other embodiments, the system uses default images if no database entries exist.

The provided music is read from the CD and analyzed to generate game events for the game. The analysis identifies musical events and, in some embodiments, determined musical properties for each. In another embodiment, additional analysis is performed on the selected musical content. For example, in addition to performing a pitch analysis both a rhythm-focused analysis and a pitch-focused analysis may be performed on the selected musical content. The additional analysis can be performed prior to the start of gameplay or dynamically during gameplay, as described in more detail below.

In one embodiment, gameplay consists of the game-player capturing the gems as they approach the game-player from the band member while the gems are within the target markers 140, 142, 144. Capturing the gems correctly provides unaltered playback of the selected music that is synchronized to the captured gem. If the gems are not captured correctly, the playback of the selected music is altered, or omitted entirely, to indicate that the gem was not captured.

In another embodiment, the game-player is able to switch between band members 102, 104, 106. Switching to another band member also switches the underlying analysis method and therefore the resulting placement and number of gems. Continuing with the example from above, if the game-player switches, using the input device, from the vocalist 102 to the drummer 106, the gems are now generated in response to the results of the rhythm-related analysis. As previously stated, this analysis can be performed as part of the game generation or dynamically during game play.

Additionally, this type of analysis and game generation provides for a multiplayer environment. Both head-to-head and cooperative gameplay can be provided. For example, a first player can select to capture gems associated with the vocalist 102 and a second player can select to capture gems associated with the drummer 106. The player that captures the most gems correctly is declared the winner. Alternatively, the first player's and the second player's score can be aggregated to provide an overall score. The overall score is used to determine whether the team of players advances to another game level.

### Example 2

With reference back to FIG. 2, an example of generating a video game and corresponding game play is described below. As shown, the beat blaster 210 captures the gems 230 as they approach the beat blaster 210 on the track 220. The selected music is analyzed to generate the gems that are captured by the user. In one embodiment, the analysis is performed for a salient musical property (e.g., a melody line). The resulting game events are displayed in the lane 220. In another embodiment, additional analysis is performed on the selected musical content. For example, in addition to performing a pitch analysis both a tempo focused analysis and a pitch focused analysis are performed on the selected musical content. The additional analysis can be performed prior to the start of gameplay or dynamically during gameplay, as described in more detail below.

In one embodiment, gameplay consists of the game-player capturing the gems 230 as the approach the beat blaster 210. Capturing the gems correctly provides unaltered playback of the selected music that is synchronized to the captured gem. If the gems are not captured correctly, the playback of the selected music is altered to indicate that the gem was not captured.

In another embodiment, the game-player is able to switch among a plurality of lanes. Each lane corresponds to a respective type of analysis performed on the selected musical content. As such, the resulting placement and number of gems can be different for each lane. Also, like the example provided with reference to FIG. 1 multiplayer gameplay is possible using this style of video game environment.

### Example 3

With reference back to FIG. 4, an example of generating a dance-along video game and corresponding game play is described below. For example, if the game player selects musical content the game player to which the user wants to dance. The selected music is analyzed for percussive events. The musical properties of the identified events are used to select arrows to be displayed to the player. Thus, as described above, a bass-snare-bass-bass-snare pattern may generate a left-right-left-left-right pattern corresponding arrows 402, which provide dance instructions to the game player. By way of further example, the loudness of identified events may be used to determine how fast new arrows 402 appear. Events having more loudness may be displayed longer before a subsequent arrow 402 is displayed to the user.

### Example 5

In one embodiment, the game player is in possession of an iPod portable music/video player. As is known, the iPod is a portable music and video device having a housing that stores various computation means. For example, a processor, memory, and software for playing the music and video stored within the memory. It is assumed that the iPod includes one or more stored music files purchased or otherwise obtained by the game player. From the menu options provided by the iPod the game player navigates to and selects an option labeled, for example, “play video game.” In response, the iPod displays a splash screen or the like to the game player on the display of the iPod presenting the name of the videogame and the proper credits.

Next, the game player selects the music file that is used to create the video game. In response, the iPod processes the selected music as described above and displays a game level to game player on the display of the iPod. It should be understood that because the computer that executes the associated iTunes application has, in most cases, greater processing power, the selecting of music, processing thereof, and generating of the game event data can occur at the computer associated with the ipod, rather than the iPod itself, with said game event data subsequently being transmitted to the iPod.

Once the video game data is generated, play begins. In this example, assume that the video game is a rhythm-based musical game similar that described above with reference to FIG. 2. As the gems approach the game player and pass through target points, the game player depresses a section of the input device (e.g., the clickwheel) of the iPod. For example, gems in the left third of the screen are captured by depressing the clickwheel at approximately nine o'clock, gems in the middle third of the screen are captured by depressing the clickwheel at approximately twelve o'clock, and gems in the right third of the screen are captured by depressing the clickwheel at approximately three o'clock.

In another embodiment, the clickwheel senses the motion of the game player's finger. As such, a scooping style game play is used. As described with reference to FIG. 1, the player operates a “scoop” that slides back and forth along the lane (or other visual display of the musical time axis). The player must keep the scoop aligned with the game elements as they flow to the game scoop. When the game player moves his finger in a counter-clockwise motion the scoop moves to the left. When the game player moves his finger in a clockwise motion the scoop moves to the right, requiring the game player to provide input with greater frequency and accuracy.

The frequency at which gems appear to the game player for capture can be function of the music selected, the difficulty setting of the game provided by the player prior to game generation (e.g., novice, skilled, and advanced), or the type of analysis program used by the software. It should be understood that any combination of the previous functions can be used.

When the user successfully captures a gem correctly, the portion of the selected music that corresponds to the gem is played to the user without modification. If the gem is not captured, the portion of the selected music that corresponds to that gem is modified prior to being played back to the game player. In one embodiment, if the user successfully captures a series of gems an extended portion of the selected music is played back to the game player without modification. Examples of modification can include by are not limited to adding reverberation to the selected music, filtering the selected music, playing only a portion of the selected music, adjusting the volume of the supplied music and the like. In some embodiments, the music is played back without modification even when the player is not playing correctly.

Although the previous example has been given with response to an iPod music and video player, the concepts can be applied to other portable music and video players. For example, the Zen, MuVo, and Nomand players sold by Creative Technology, Ltd of Singapore.

### Example 6

In one embodiment, the game player is in possession of a PSP portable music/video player. As is known, the PSP is a portable music and video device having a housing that stores various computation means. For example, a processor, memory, and software for playing the music and video stored within the memory. Also, the PSP includes an interface for receiving a Universal Media Disk (UMD). In this example, it is assumed that the PSP includes one or more stored music files purchased or otherwise obtained by the game player. In one embodiment, a UMD disk is inserted into the PSP that includes the analysis and video game generation software described above. In another embodiment, the software is shipped with the PSP device. In yet another embodiment, the software is stored on a Memory Stick that is inserted in the PSP. At the start of the video game, the PSP displays a splash screen or the like to the game player on the display of the PSP presenting the name of the video game and the proper credits.

Next, the game player selects the music file that is used to create the video game. In response, the PSP processes the selected music as described above and displays a game level to game player on the display of the PSP. The music selectable by the user is stored on a Memory Stick that is all inserted in the PSP. In other embodiments, the PSP is networked to another storage device of PSP and accesses the music therefrom.

Once the video game is generated, play begins. In this example, assume that the video game is a rhythm-based musical game similar that described above with reference to FIG. 2. As the gems approach the game player and pass through target points, the game player depresses a one or more of the triangle, square, circle, or x buttons. For example, gems in the left third of the screen are captured by depressing the square button, gems in the middle third of the screen are captured by depressing the triangle button, and gems in the right third of the screen are captured by depressing the circle button.

When the user successfully captures a gem correctly, the portion of the selected music that corresponds to the gem is played to the user without modification. If the gem is not captured, the portion of the selected music that corresponds to that gem is modified prior to being played back to the game player. In one embodiment, if the user successfully captures a series of gems an extended portion of the selected music is played back to the game player without modification.

Further, in other embodiments the video game features both multiplayer and head-to-head game play as described above in connection with EXAMPLE 1. In a multiplayer embodiment, each player using their own portable device that are in communication using IrDA or Bluetooth technologies or using a single portable device having multiple controllers connected thereto, cooperate to complete a game level

This “battle of the bands” style game play may also be used in head-to-head competition that occurs across a network. For example, teams of multiple game players can form a “band” and compete against other “bands.” The band that captures the most game events for a given musical content correctly is deemed the winner.

Also, single game player head-to-head style game play can be used. In such game play style, each individual game player is charged with capturing game events. The player who captures more game events correctly is deemed the winner. The players can compete against each on a single music and video player or using multiple music and video players that communicate using know networking techniques.

What is claimed is:

1. A method for dynamically creating video game content using musical content from a source other than the game, the method comprising the steps of:
(a) analyzing musical content to identify at least one musical event extant in the musical content;
(b) determining a salient musical property associated with the at least one identified musical event; and
(c) creating a video game event synchronized to the at least one identified musical event and reflective of the determined salient musical property associated with the at least one identified event.

2. The method of claim 1, wherein step (b) comprises determining the occurrence of a musical section change.

3. The method of claim 2 wherein step (c) comprises creating a video game event synchronized to the occurrence of the musical section change.

4. The method of claim 1, wherein step (b) comprises determining the occurrence of a musical phrase.

5. The method of claim 4 wherein step (c) comprises creating a video game event synchronized to the occurrence of the musical phrase.

6. The method of claim 1, wherein step (b) comprises determining timbre associated with the at least one identified event.

7. The method of claim 1, wherein step (b) comprises determining pitch range associated with the identified event.

8. The method of claim 1, wherein the step (b) comprises determining loudness associated with the at least one identified event.

9. The method of claim 1 wherein step (c) comprises creating, while a player is interacting with a video game, a video game event synchronized to the at least one identified musical event and reflective of the determined salient musical property associated with the at least one identified event.

10. The method of claim 1 wherein step (c) comprises creating, prior to a player interacting with a video game, a video game event synchronized to the at least one identified musical event and reflective of the determined salient musical property associated with the at least one identified event.

11. The method of claim 1 further comprising altering video game visual content responsive to the determined salient musical property associated with the identified musical events.

12. The method of claim 1 further comprising the step of identifying a predetermined number of musical events to be a musical phrase.

13. A method for dynamically creating video game content using musical content from a source other than the game, the method comprising the steps of:
(a) analyzing musical content to identify at least one musical event;
(b) creating a video game event synchronized to the at least one identified musical event;
(c) modifying the at least one musical event responsive to player input; and
(d) outputting the modified at least one musical event.

14. The method of claim 13 wherein step (c) comprises selecting a modified version of the at least one musical event responsive to player input.

15. The method of claim 13, wherein step (c) comprises filtering the audio output of the game responsive to player input.

16. The method of claim 13, wherein step (c) comprises adjusting the volume of the audio output of the game responsive to player input.

17. The method of claim 13, wherein step (c) comprises applying an audio effect to the audio output of the game responsive to player input, the effect selected from the group of reverberation, delay, echo, flange, phase, and attack modification.

18. A portable music and video device housing a memory for storing executable instructions and a processor for executing the instructions, the memory comprising instructions that cause the processor to:
(a) execute a video game stored in the memory and having a game event that is synchronized to a musical event of musical content supplied from a source other than the video game; and
(b) display the video game on a display of the portable music device.

19. The portable device of claim 18 further comprising instructions to affect the audio output of the video game in response to performance of a game player.

20. The portable device of claim 18 further comprising instructions to receive game input from a user.

21. The portable device of claim 18, wherein the game event reflects a salient musical property of the musical event.

22. The portable device of claim 18, wherein the salient musical property is selected from the group consisting of timbre, tone color, pitch range, and loudness.

23. The portable device of claim 18, wherein the musical event is the occurrence a musical phrase.

24. The portable device of claim 18, wherein the musical event is a musical section change.

25. The portable device of claim 18 further comprising instructions to modify the audio output when the game player does not execute a game event.

26. The portable device of claim 18 further comprising instructions to modify the audio output when the game player successfully executes a game event.

27. The portable device of claim 18, wherein the device is an iPod.

28. The portable device of claim 18, wherein the device is a PSP.

29. A method for altering at least one visual property of a video game responsive to musical content from a source other than the game, the method comprising the steps of:
(a) determining a salient musical property associated with at least one musical event extant in the musical content; and
(b) altering a visual property reflecting the determined salient musical property.

30. The method of claim 29 wherein step (b) comprises altering the visual property reflecting the loudness of the musical content.

31. The method of claim 29, wherein step (b) comprises altering the visual property reflecting the timbre of the musical content.

32. The method of claim 29, wherein step (b) comprises altering the visual property reflecting the frequency distribution of the musical content.

33. The method of claim 29 wherein step (b) comprises altering the lighting of the video game reflecting the determined salient property.

34. The method of claim 29 wherein step (b) comprises altering the color of at least one video game element reflective the determined salient property.

35. The method of claim 29 wherein step (b) comprises altering animations included in the video game reflective the determined salient property.

36. The method of claim 29 wherein step (b) comprises altering particle system parameters included in the video game reflective the determined salient property.

37. The portable device of claim 18, wherein the device is a cellular telephone.
